(19) United States
(12) Patent Application Publication
(10) Pub. No.: US 2019/0082756 A1
(43) Pub. Date: Mar. 21, 2019

(54) LED LIGHTED PLACARD SYSTEM FOR APPAREL OR GEAR, AND MANUFACTURING METHOD THEREFORE

(71) Applicant: Michael Arno, Clarence, NY (US)

(72) Inventor: Michael Arno, Clarence, NY (US)

(21) Appl. No.: 16/135,951

(22) Filed: Sep. 19, 2018

Related U.S. Application Data
(60) Provisional application No. 62/561,491, filed on Sep. 21, 2017.

(51) Int. Cl. A41D 27/08; G09F 21/02; F21V 33/00

(52) U.S. Cl. CPC A41D 27/085; F21V 33/0008; G09F 21/02

(57) ABSTRACT

A ‘placard’ lighting system of shapes, such as a logo, or other common form, that is attached to apparel, such as a shoe, backpack, jacket, etc. The placard receives display information communications via radio frequency (RF) signals transmitted through an application (APP) running on a smartphone. Varieties of colored light and intensity of luminance signals are generated and received from a user's smartphone APP to the apparatus, or from a nearby user running the APP on his or her smartphone (when the APP is in an ‘OPEN’ channel mode). In this scenario, as the two individuals operating their apparatuses pass each other in close proximity (within range), they would ‘share’ display information data in unison, making apparel images illuminate in a harmonious manner. As they would separate again, out of each other's range, they would go back to their original, independent display settings.

### CROSS REFERENCE OF RELATED APPLICATIONS

This application claims the benefits of U.S. provisional application No. 62/561,491 filed Sep. 21, 2018 and entitled “IMPROVED LED LIGHTED PLACARD SYSTEM FOR APPAREL OR GEAR, AND MANUFACTURING METHOD THEREFORE,” which provisional application is incorporated by reference herein in its entirety.

### FIELD OF THE INVENTION

The present disclosure relates generally to illuminating placards featuring light emitting diodes (LED's) that are meant to be placed on apparel and other gear. More so, the present disclosure relates to a method, and manufacturing means of said method, for users to control the placards via a smartphone application (App). Specifically, users are able to control colors, symbols, images, words, etc. that the placard displays.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present disclosure, or any embodiments thereof, to anything stated or implied therein or inferred thereupon.

In the field of Light Emitting Diode (LED) lighting devices, there exists a means to produce any color of light using just the three primary light colors of RED, BLUE and GREEN, so-called RBG; including white light. LED's have a wide variety of uses, and have been integrated with clothing and other apparel.

### SUMMARY OF THE INVENTION

Illustrative embodiments of the disclosure are generally directed to a ‘placard’ lighting system of shapes, such as a logo, or other common forms, that would be attached to apparel such as a shoe, a backpack, a jacket, etc. The lighting system of the present invention receives display information communications via radio frequency (RF) signals, transmitted through an application (APP) running on a smartphone. Wherein such display information would result in the placard shape, disposed on the apparel, illuminating in both a variety of colored light and intensity of luminance.

The disclosure includes easy methods for applying the hermetically sealed illuminating placards to apparel. This includes a method for convenient after-market installation by the user, himself, and a method for manufacturers to install the placard on to the apparel before it is put in the marketplace.

A general object of the present invention is to allow users to communicate with the placard with signals generated and received from a user's smartphone APP, or from a near-by like user running the APP on his or her smartphone (when the APP is in an ‘OPEN’ channel mode). In this scenario, as the two individuals with operating placards pass each other in close proximity (within RF range), the APPs would ‘share’ display information data in unison; thereby making apparel images illuminate in a harmonious manner. As the users separate again, out of each other's phone's range, they would go back to their original, independent display settings.

Another object of the present invention is for the placard lighting system to display a variety of color patterns selected from a color matrix, color wheel, or color gradient.

Another object of the present invention is for users to select the color displayed by the placard lighting system from a smartphone APP.

Another object of the present invention is for the placard lighting system to display color patterns in synchrony with the cadence, rhythm, tempo, beat, etc. from a song being played on a user's smartphone.

Still another object of the present invention is to fabricate the placard lighting system as a hermetical, or self-contained package. The hermetical would allow for easy attachment on to almost any surface by the means of a “high-tack” adhesive. This can be done by the producers of apparel during the manufacturing process or by consumers after purchase.

Still another object of the present invention is to allow the placard lighting system the means to recharge its battery housed within the hermetical.

Yet another object of the present invention is for the radio frequency (RF) communications between the user's smartphone and the placard lighting system to operate via Bluetooth technology or ZigBee technology, configured for low-power, close-range simplex operation.

Yet another object of the present invention is to incorporate the placard lighting system into any style, type, or shape of hermetical package to conform to a desired surface; wherein such style, type, or shape is a side of a shoe, a front toe covering of a shoe, a heel portion of a shoe, a flap of a backpack, a side or front of a jacket, or a similar surface of nearly any apparel or gear.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The disclosure will now be described, by way of example, with reference to the accompanying drawings, in which:

FIG. 1 illustrates a perspective view of a placard lighting system as a logo on shoe apparel along with a smartphone running an application directing illumination of said logo shaped placard on the shoe, in accordance with an embodiment of the present disclosure;

FIG. 2 illustrates a perspective view of placard lighting system affixed to the side of a shoe apparel, in accordance with an embodiment of the present disclosure;

FIG. 3 is an exploded, perspective view of FIG. 2, showing all major components of a placard lighting system and their relationships to one another, in accordance with an embodiment of the present invention;

FIG. 4 is an illustration of the application (APP) running on a smartphone, showing the program mode for color selections, menu, and features, in accordance with an embodiment of the present invention;

FIG. 5a through 5c illustrate various placard lighting systems in the shapes of familiar proprietary logos, representing various manufacturers of apparel and gear, and placed on a shoe, in accordance with an embodiment of the present invention;

FIG. 6a through 6c illustrate various placard lighting systems of generic shapes and forms, and placed on a shoe, in accordance with an embodiment of the present invention;

FIG. 7a through 7c illustrate various placard lighting systems in the shape and form of sports teams' logos, symbolic icons, and phrases, respectively, in accordance with an embodiment of the present invention;

FIG. 8 illustrates a simplified electronic schematic of an exemplary method of controlling a placard lighting system of various shapes, where means to charge a battery, receive display information data, process signals, drive a multicolor LED circuit, and an LED array are operationally used, in accordance with an embodiment of the present invention.

Like reference numerals refer to like parts throughout the various views of the drawings.

### DETAILED DESCRIPTION OF THE DISCLOSURE

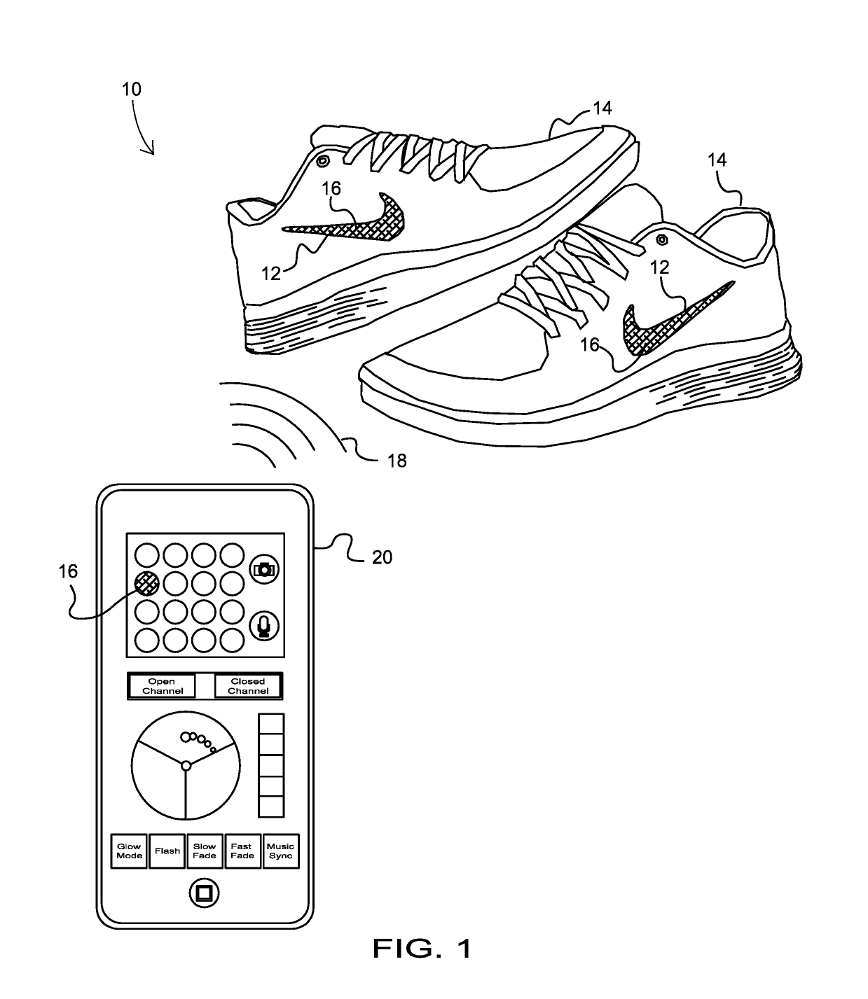

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

FIG. 1 displays a typical use of the placard lighting system of shapes 10. Light image area 12, article of apparel or gear 14, APP 20 (running on a smartphone), color selection 16 and radio frequency transmission of display data signal 18 are disclosed. APP 20 outputs operational information, such as desired color or color selection 16, via display data signal 18, which is received by placard lighting system 10. Light image area 12 then displays the selected color or colors until the next transmission of display data signal 18 is received to update the display color pattern of lighting.

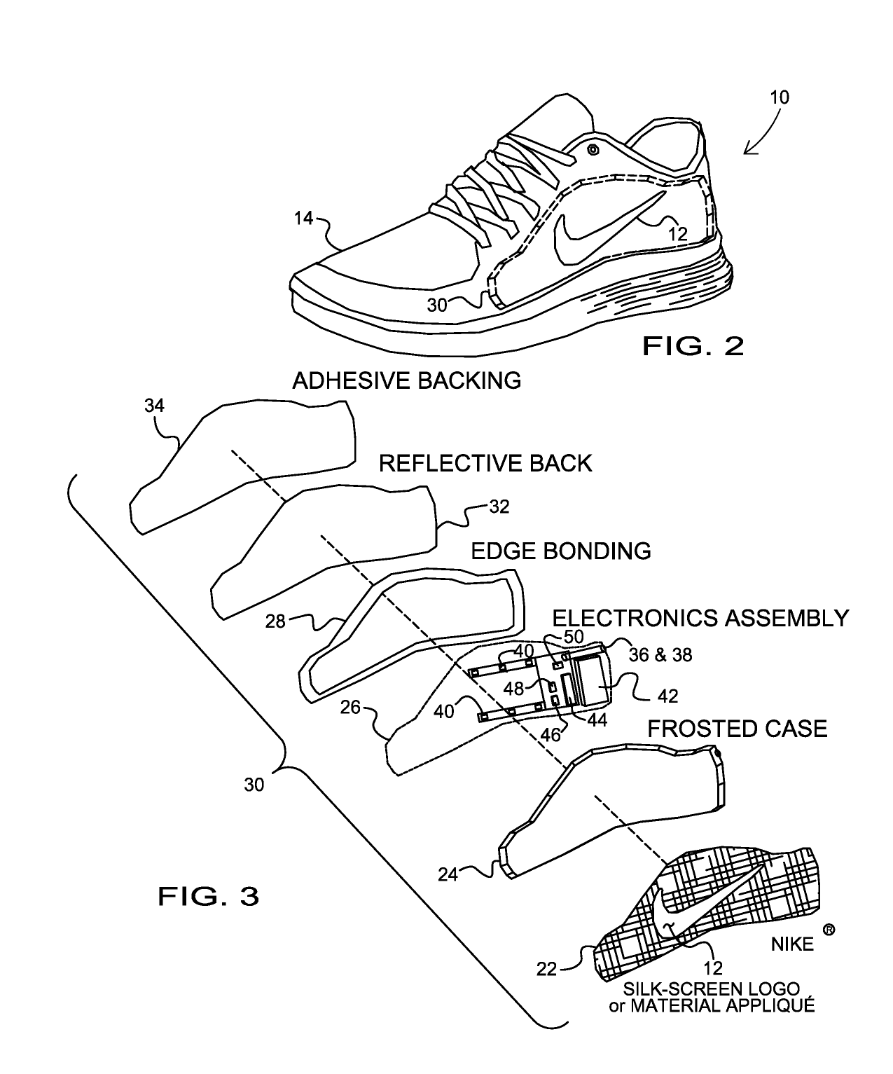

FIG. 2 displays placard lighting system 10 as part of a fully configured placard lighting assembly 30. Placard lighting assembly 30 is attached to a shoe side panel (for article of apparel or gear 14) and has a popular shoe manufacturer Nike®, logo (Nike, Inc., One Bowerman Drive, Beaverton, Oreg. 97005, U.S.A.).

FIG. 3 is an exploded, perspective view of placard lighting assembly 30 of FIG. 2, showing all major components of placard lighting system 10 of shapes and their relationship to one another, in accordance with an embodiment of the present invention. FIG. 3 includes applique 22, which can be a silk-screen process or a fabric sewn to an image comprising image area 12, frosted case 24, electronics assembly 26, edge bonding 28, reflective back 32 panel, and high-tack adhesive backing 34.

When applique 22 is affixed to frosted case 24, the light generated by the LED's defuses and passes through image area 12, illuminating any image depicted in image area 12. Electronics assembly 26 is semi-flexible, and sandwiched between frosted case 24 and reflective back 32 by edge bonding 28. Edge bonding 28 hermetically seals the assembly together (all except the tiny access of the recharge battery port that will be discussed later). Reflective back 32 further disperses and scatters light that is being generated by the LED's, and has high-tack adhesive backing 34 to apply placard lighting assembly 30 to any article of apparel or gear 14.

It is important to understand that placard lighting assembly 30 can be affixed in manufacturing via a sewn or stitched process instead of the use of adhesive backing 34. If placard lighting system 10 is sold as an after-market item (placard lighting assembly 30), then adhesive backing 34 has a removable non-stick paper (not shown) that is removed during the application of placard lighting assembly 30, comprising the placard lighting system 10 to a user apparel, attire, gear or desired article.

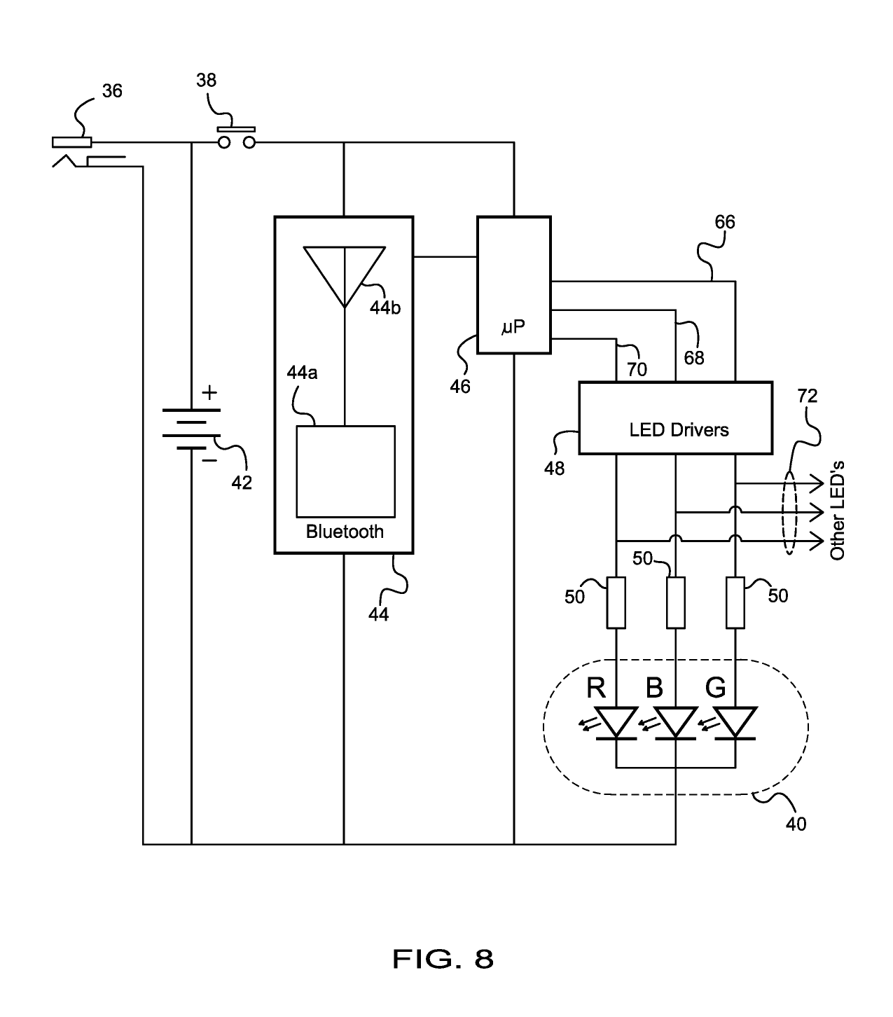

FIG. 3 displays the physical location of major electrical components. Recharging port 36, power ON/OFF switch 38, rechargeable battery 42, radio frequency (RF) receiver link 44, microprocessor 46, LED driving circuit 48, current limiting device 50, and array of R-B-G LED 40 are all mounted on and compose semi-flexible electronics assembly 26. The operations of electronics assembly 26 are fully discussed in FIG. 8.

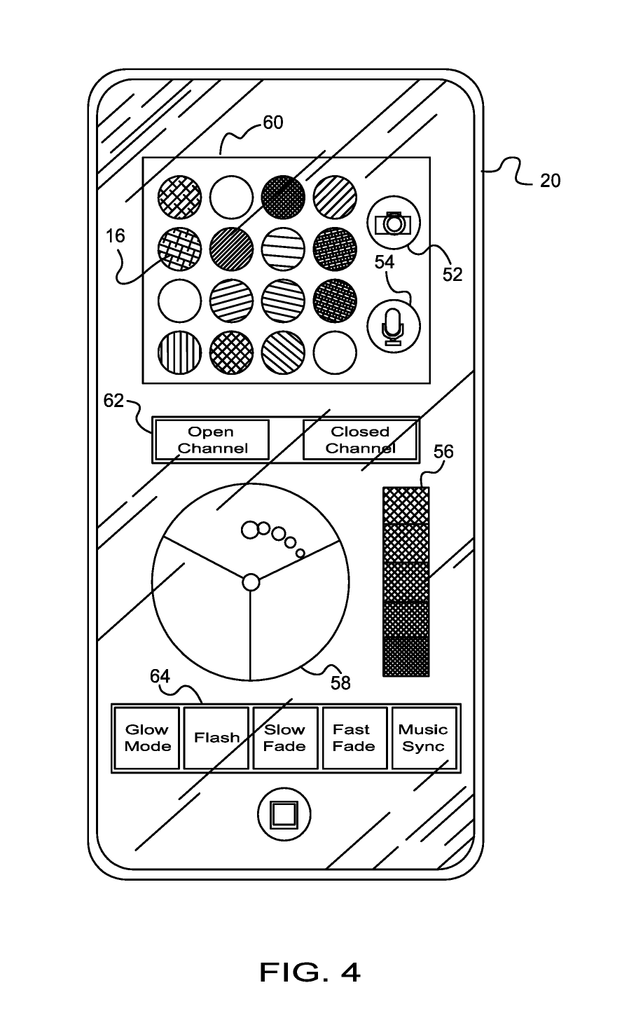

FIG. 4 illustrates the application (APP) 20 running on a smartphone. It shows the program mode for color selections, menu and features, in accordance with an embodiment of the present invention. APP camera button 52, APP microphone button 54, APP gradient scale 56, APP color-wheel 58, APP color-selector panel 60, APP channel-selector 62, and APP function-selector 64 are arranged on APP 20 for easy user interface. Each of the APP assortment of features, in some way, control the color, intensity rate of change, task, accessibility, and performance in the control of placard lighting assembly 30.

For example, within APP color-selector panel 60, there are several color selection patterns 16, each having an individual color, such as violet, indigo, blue, green, yellow, orange, red, etc., that can be easily chosen by simply touching any desired color selection pattern button 16 on the smartphone touchscreen. APP gradient scale 56 controls the tone of color's intensity. A full spectrum of color selections is available via APP color-wheel 58. Still further, a color could be inputted by using APP camera 52 button. Using APP camera 52, an individual points the smart phone at a colored object, such as a tee shirt. The smartphone's camera enters the object's color into APP gradient scale 56. Using APP microphone 54 button, users can say a color into the smartphone, and the smartphone mic equates the word to a color on APP gradient scale 56, which is then transmitted to placard lighting assembly 30.

By any of the color selection means, of one or more colors, would result in the user's desired color and tone to be transmitted (via display data signal 18), to the placard lighting assembly 30 apparatus, and, would illuminate the R-B-G LED 40 array to the exact color and tone. Exactly how each color is derived by the LED is fully detailed in FIG. 8.

Smartphone APP program 20 of the present invention functions in a number of user selected operations that allow one, two, or more colors via APP function-selector 64 buttons. Such operations include ‘Flash’, ‘Slow Fade’, ‘Fast Fade’ or ‘Music Sync’ (color display in synchrony with music being played on the smartphone or heard by the smartphone microphone). Any color or colors inputted and selected would result in placard lighting assembly 30, specifically light image area 12, illuminating with said color(s) and responding to any selected operation. When the ‘Glow Mode’ button is selected, light image area 12 on placard lighting assembly 30 directly goes to the brightest setting of white light. This feature can be very useful for safety, allowing others to better see the user and the user to better see where he is walking. The glow feature would be a steady ON state of illumination for such needs and safety considerations.

Setting APP channel-selector 62 to ‘Closed Channel’ allows signals generated by the user's APP program 20 to only be accepted, in whatever color and pattern desired, by placard lighting assembly 30. However, if APP channel-selector 62 is set to ‘Open-Channel’, any control signals (display data signal 18), if recognized and in range, would ‘mix-in’ with the user's own signal. In this way, two or more users of different placard lighting systems 10 could share LED lighting data. In this scenario, when two or more users first greet each other as they approach and come into range, they see each other's apparatus (placard lighting assembly 30), illuminate the light image area 12. For example, if first user displays an orange pattern (‘color’ selection 16), a second user displays a purple pattern in the ‘color’ selection 16, and both have APP channel-selector 62 set to ‘Open Channel’ mode, their individual light image areas 12 cycle, alternating in orange and purple illumination. Thus, both users share their independent display data signals 16 settings. All of this can assist as a social communicator, a raconteur of color lighted apparel and gear when friends meet and greet, to aid in their collective interest.

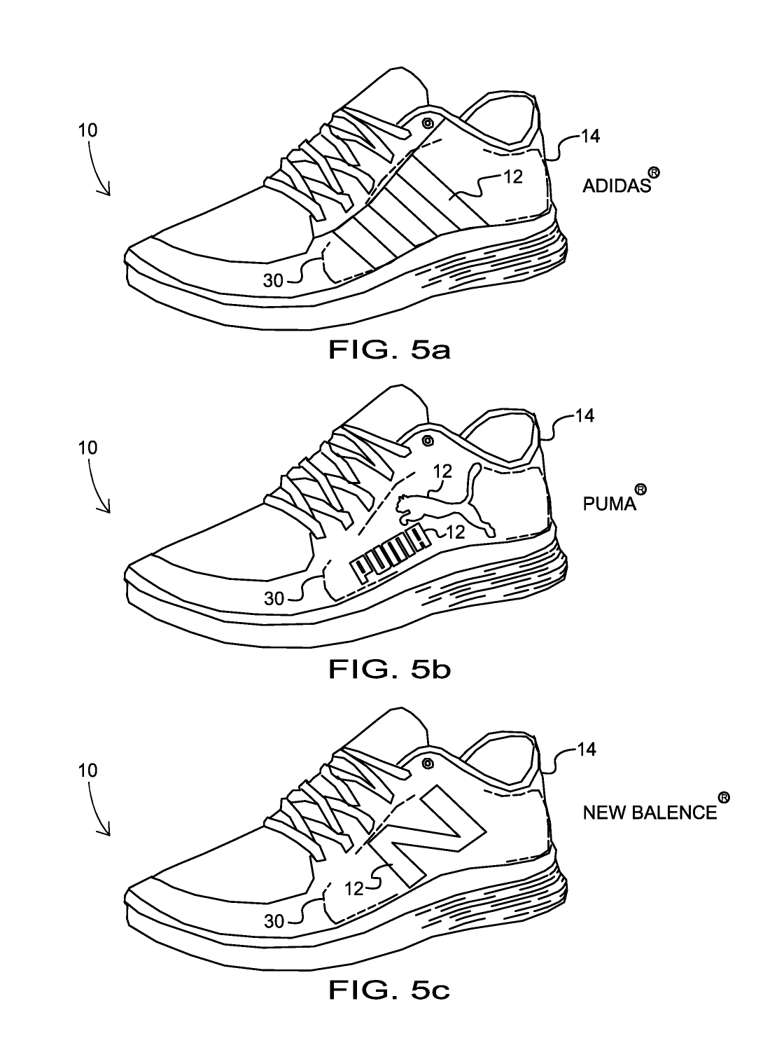

FIG. 5a through 5c display other various placard lighting systems 10 in familiar proprietary logos and placed on a shoe, representing various manufacturers of apparel and gear (of the present invention of FIG. 3) in accordance with an embodiment of the present invention. FIG. 5a displays the logo and style of ADIDAS® (Adidas USA Corporate Headquarters, 5055 N. Greeley Ave., Portland, Oreg. 97217, U.S.A.) in light image area 12 on the surface of placard lighting assembly 30 affixed to a side panel of a shoe, article of apparel, or gear 14.

FIG. 5b displays the logo and style of PUMA® (Puma USA Corporate Headquarters, Puma Way 1, 91074 Herzogenaurach, Germany) in light image area 12 on the surface of placard lighting assembly 30 affixed to a side panel of a shoe, article of apparel, or gear 14. Lastly, FIG. 5c displays the logo and style of NEW BALANCE® (New Balance Athletic Shoe, Inc., Corporate Headquarters, Brighton Landing, 20 Guest St., Boston, Mass. 02135, U.S.A.) in light image area 12 on the surface of placard lighting assembly 30 affixed to a side panel of a shoe, article of apparel, or gear 14.

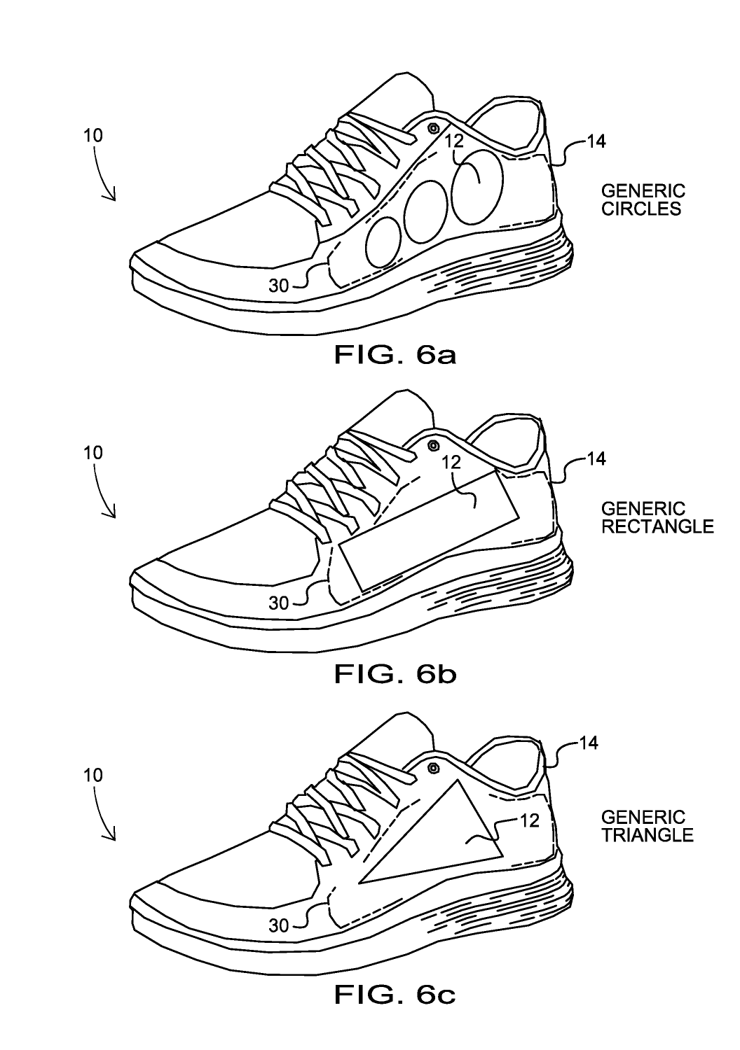

FIG. 6a through 6c are further examples of other various placard lighting systems 10 in generic forms and placed on a side panel of a shoe in accordance with an embodiment of the present invention. FIG. 6a displays circles in light image area 12 on the surface of placard lighting assembly 30 affixed to a side panel of a shoe, article of apparel, or gear 14. Similarly, FIG. 6b displays a rectangle in light image area 12 on the surface of placard lighting assembly 30 affixed to a side panel of a shoe, article of apparel, or gear 14. Lastly, FIG. 6c displays a triangle in light image area 12 on the surface of placard lighting assembly 30 affixed to a side panel of a shoe, article of apparel, or gear 14. FIGS. 6a, 6b & 6c represent any generic shape of a light image area of the present invention.

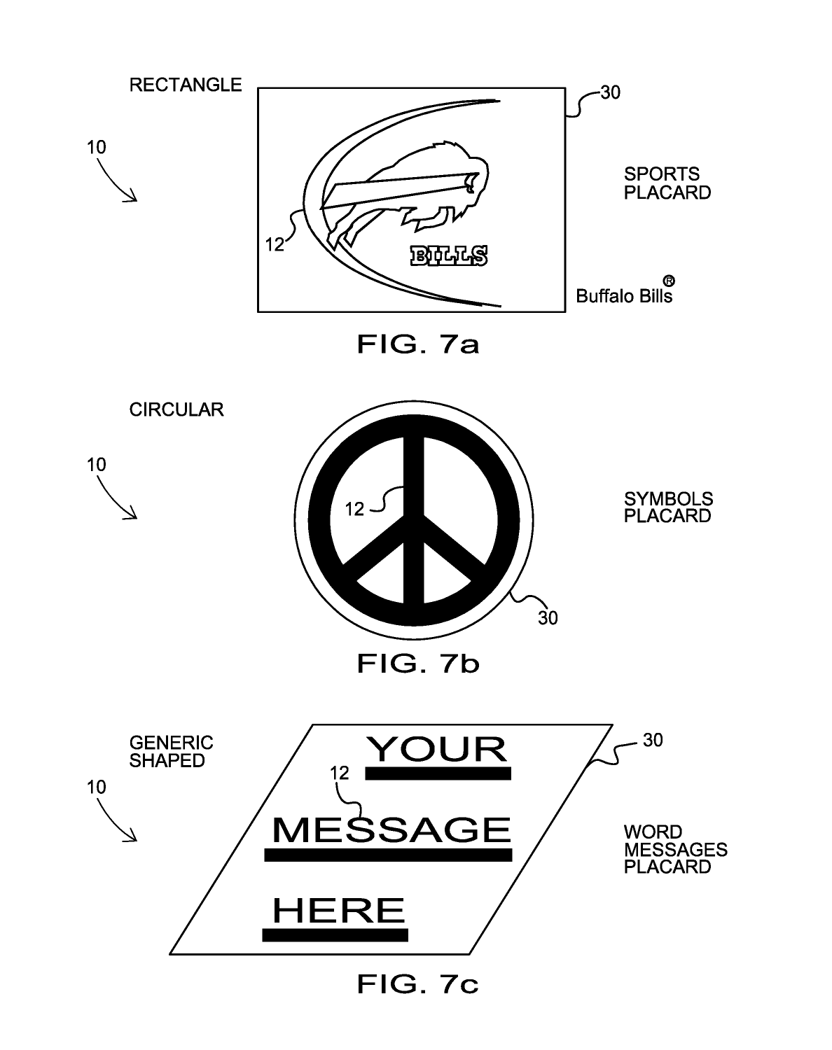

FIG. 7a through 7c are yet further examples of other various placard lighting systems 10 of shapes in the form of sports teams' logos, symbolic icons, and worded placards, respectively, in accordance with an embodiment of the present invention. The image of the National Football League BUFFALO BILLS® (Buffalo Bills Corporate Office Headquarters, 1 Bills Dr., Orchard Park, N.Y. 14127, U.S.A.) franchise logo is in light image area 12 on the surface of placard lighting assembly 30. FIG. 7b shows familiar symbols as light image area 12 on the surface of placard lighting assembly 30, and FIG. 7c indicates any ‘message’ can be on light image area 12 on the surface of placard lighting assembly 30. FIGS. 7a, 7b and 7c represent any franchise logo, any symbol, or any message, in any shape, of a light image area 12 of the present invention. They are affixed (via the applique 22 process as shown in FIG. 3) to placard lighting assembly 30 and placed on an article of apparel or gear 14, becoming a placard lighting system 10, and are responsive to display data signals 18 that illuminate light image area 12 with ‘color’ selection 16 patterns generated from a smartphone APP program 20.

FIG. 8 displays a simplified electronic schematic diagram (of the electronic assembly 26), showing an exemplary method of controlling placard lighting system 10, wherein means to charge a battery, receive display information data, process signals, drive a multicolor LED circuit, and an LED array are operationally used in accordance with an embodiment of the present invention. As mentioned in FIG. 3, the details of major electrical components are represented here in FIG. 8. Recharging port 36, power ON/OFF switch 38, rechargeable battery 42, radio frequency (RF) receiver 44 link (having controller 44a and antenna 44b disposed thereon), microprocessor 46, LED driving circuit 48, current limiting device 50, and array of R-B-G LED 40; are all mounted on and comprise semi-flexible electronics assembly 26. The operation of electronics assembly 26 is in the follow paragraphs.

Note, the tri-color red, blue and green (R-B-G LED 40) devices are otherwise known as R-G-B (red, green & blue). They, also, are manufactured in both a common anode or common cathode design. The inventors have specified the common cathode type as displayed in the FIG. 8 electrical schematic.

When needed, a conventional low-voltage battery charging supply (not shown) is connected to recharging port 36 to charge placard lighting assembly's 30 rechargeable battery 42. There is a power ON/OFF switch to selectively power the unit. When operating, signal with instructions come from smartphone APP program 20 via short-range Bluetooth communications, wherein the display data signal is received at the Bluetooth radio frequency RF receiver link 44 at antenna 44b. Bluetooth link 44 controller 44a transfers said signals to microprocessor 46, which parcels the signals to individual color segments over line RED SIGNAL 70, line BLUE SIGNAL 68, and line GREEN SIGNAL 66 to LED driver circuit 48. LED driver circuit 48 controls the amplitude of the signal that is delivered to current limiting devices 50 and then to R-B-G LED's 40 array. In this configuration, R-B-G LED's 40 has a common ‘cathode’ that is returned to the (−) terminal of battery 42. The individual ‘anodes’ of RED, BLUE & GREEN LED's (of R-B-G LED 40 diode) are excited with current to illuminate to an intensity in order to produce a desired color. The below table shows a mixture of the red, blue and green ‘amplitude’ of the primary colors of light that can generate any color in the spectrum of light.

SPECTRUM OF LIGHT R-B-G TABLE:

| COLOR | R | - | B | - | G |
|---|---|---|---|---|---|
| WHITE | 255 | | 255 | | 255 |
| VIOLET | 127 | | 255 | | 0 |
| BLUE | 0 | | 255 | | 0 |
| BLUE CYAN | 0 | | 255 | | 127 |
| CYAN | 0 | | 255 | | 255 |
| GREEN CYAN | 0 | | 127 | | 255 |
| GREEN | 0 | | 0 | | 255 |
| GREEN YEL | 127 | | 0 | | 255 |
| YELLOW | 255 | | 0 | | 255 |
| ORANGE | 255 | | 0 | | 127 |
| RED | 255 | | 0 | | 0 |
| RED MAGENTA | 255 | | 127 | | 0 |
| MAGENTA | 255 | | 255 | | 0 |
| OFF | 0 | | 0 | | 0 |

It should be obvious that mixing different values of R-B-G can produce thousands (millions) of different colors. The inventors have listed the common values in the table to represent the 256 possibilities in a 2 to the 8^{th} scheme, where 0-0-0 equals full OFF and 255-255-255 equals full ON for R-B-G LED's 40 array. APP program 20 generates the appropriate red, blue, and green mixture and transmits display data signal 18 (in a R-B-G sequence), representing a ‘0’ to ‘255’ of amplitude for each color of R, B and G. Said signal is processed in microprocessor 46, where it is issued to LED driver circuit 48, delivering an appropriate current level to excite each anode (R-B-G) of LED array 40. Placard lighting assembly 30 receives said signal via antenna 44b.

A few words about the ‘OPEN-CHANNEL’ and ‘CLOSE-CHANNEL’ operations mentioned above need to be disclosed in regards to the unique sharing of display data signal 18. The user, upon first activating placard lighting system 10 and APP 20, is given a ‘configure’ menu to identify the devices being paired. Should the two devices get out of sync, users are able to do and re-do this configuration process as needed. To enter the configure mode, the user simply turns the ON/OFF switch 38, rapidly on, then off, then back on while APP 20 is in the configure mode. Doing this gives placard lighting assembly 30 a new sync identification code, associating the two apparatuses as a pair. From here, ‘OPEN-CHANNEL’ and ‘CLOSE-CHANNEL’ operate as described above.

One further disclosure on display data signal 18 is that each instruction stream of data consists, for example, of a four (eight-bit) binary word instruction. The first word is the pair identifier and its open or closed channel setting. The second eight-bit word is the red level of intensity (amplitude, equaling a value between 0 and 255), e.g., 00000000 for ‘0’ and 11111111 for ‘255’. Likewise, the third and fourth words are for blue and green, respectively. Both ‘binary’ and ‘decimal’ representations of a possible color value are indicated for clarity of understanding. In this manner, APP 20 signals placard lighting assembly 30, and comprising LED placard lighting system 10 of shapes, to efficiently communicate display data signal 18 of instructions, wherein the ‘COLOR’ selection 16 of lighting patterns occurs in accordance with the ‘Spectrum of Light R-B-G Table’ earlier mentioned.

The inventors have identified a suitable RF receiver link 44 as one of the Microchip Corporation's ‘low-end’ units because only a single direction in data transmission is needed in electronics assembly 26 to receive display data signal 18 of instructions. Microprocessor 46 is exemplary, also, as a Microcip Corporation PIC12F series. A source for an ultrabright, wide viewing angle, flat (4 pin) package design tri-color LED is Super Flux LED Lamp BL-FL 7680xxx from BetLux Electronics. The listed components are only examples in a preferred embodiment of the present invention. Anyone skilled in the art is able select other such components to produce placard lighting system 10.

Those skilled in electronics are able to assemble such components configured to operate and function as described. It is highly desirable to miniaturize all said circuits indicated in FIGS. 3 and 8, and as such, the use of an ASIC (Application Specific Integrated Circuit) is most useful. The inventers could employ such ASIC technology in the present invention of placard lighting system 10 when designing a particular end use device, substantially reducing the component count. This would further reduce power consumption, extending the rechargeable battery life.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed:

1. A system for color changing devices comprising:
a placard lighting system for housing a black-lite display,
the placard lighting system having a light pattern derived from variety of amplitude of light that is signaled from an application running on a smartphone;
wherein the application is configured to output the signals of instruction to be displayed;
wherein the placard lighting system is configured to receive lighting instruction signals from other like placard systems;
the placard lighting system being near a hermetically sealed unit comprising an applique, a translucent case, a semi-electronics assembly, an edge bonding, an illumination device disposed within the placard lighting system, a reflective back panel;
the translucent case and reflective back is capable of scattering light emissions produced by at least one LED array, giving even lighted display viewing area of the shape, form or lettering;
the semi-electronics assembly comprising a rechargeable battery, a microprocessor, a radio frequency receiving means, LED means, and a plurality of tri-color LED arrays;
the illumination device being capable of generating at least one color and including at least one light emitting diode (“LED”) based light source; and
a controller to control the at least one LED based light source.

2. The system for color changing devices of claim 1 wherein the placard lighting system having a housing amenable to being affixed to apparel, gear, or the like.

3. The system for color changing devices of claim 1 wherein the placard lighting system being capable of generating a variety of amplitude levels in red, blue, and green via LED arrays.

4. The system for color changing devices of claim 1 wherein the placard lighting system having a light pattern derived from variety of amplitude of light signaled from an APP running on a smartphone designed to output signals of instruction to be displayed.

5. The system for color changing devices of claim 1 wherein the placard lighting system comprising a camera to receive input color into the smartphone app.

6. The system for color changing devices of claim 1 wherein the placard lighting system having a gradient of colors to select from.

7. The system for color changing devices of claim 1 wherein the placard lighting system being capable of changing lighting modes through a smartphone app.

8. The system for color changing devices of claim 1 wherein the placard lighting system comprising a microphone to receive audio signals to command the lighting system to change colors.

9. The system for color changing devices of claim 1 wherein the placard being shaped as a logo, rectangle, or triangle.

10. The system for color changing devices of claim 1 wherein the placard lighting assembly being near-flexible.

11. The system for color changing devices of claim 1 wherein the placard lighting assembly being semi-hermitical.

12. The system for color changing devices of claim 1 wherein the lighting instruction signals, are transmitted in a four (4), eight-bit word streaming structure.

13. The system for color changing devices of claim 12 wherein where the first word is a ‘paired’ identifier along with the OPEN or CLOSED channel mode designator selection.

14. The system for color changing devices of claim 12 where in the second through forth words being the amplitude level of the RED, BLUE and GREEN color of light desired for any given lighting instruction.

15. The system for color changing devices of claim 1 wherein said app having a means to synchronize the user's smartphone app and individual display placard lighting system assemblies, as a ‘pair’ to transmit signals from the app, and receive signals at the placard lighting assembly; for instructing the lighting patterns.

16. The system for color changing devices of claim 1 wherein the placard lighting system comprising a smart phone App and a shoe, or a jacket, or a backpack.

17. A method for changing colors of a device comprising acts of:
generating a radio frequency input signal from a smart phone;
sending the radio frequency signal to a lighting system; and
controlling a lighting system via the radio frequency input signal, the lighting system including at least one LED-based light source.

18. A non-transitory computer readable medium comprising a set of instructions for changing colors for a placard lighting system, the instructions executable by a smart phone having a memory unit and processor, the set of instructions to direct the processor to perform the acts of:
generating a radio frequency input signal from a smart phone,
sending the radio frequency signal to a lighting system; and
controlling a placard lighting system via the radio frequency input signal, the lighting system including at least one LED-based light source.
